(19) United States
(12) Patent Application Publication
(10) Pub. No.: US 2008/0025791 A1
(43) Pub. Date: Jan. 31, 2008

(54) Slip or Contraction Member

(76) Inventors: Peter Godde, Dorsten (DE); Andre Jansen, Borken (DE); Robert Peters, Bocholt (DE)

Correspondence Address: ROBERT W. BECKER & ASSOCIATES, 707 HIGHWAY 333, SUITE B, TIJERAS, NM, 87059-7507, US

(21) Appl. No.: 11/830,428

(22) Filed: Jul. 30, 2007

(30) Foreign Application Priority Data
Jul. 31, 2006 (DE) 102006035946.1.

(51) Int. Cl. F16D 1/00

(52) U.S. Cl. 403/404

(57) ABSTRACT

A slip or contraction member for establishing a press connection, preferably between two concentric shafts. The slip or contraction member comprises an inner ring and an outer ring that can be tightened against one another along a conical contact surface via a screw connection. The inner ring and/or the outer ring is made of a cast iron material.

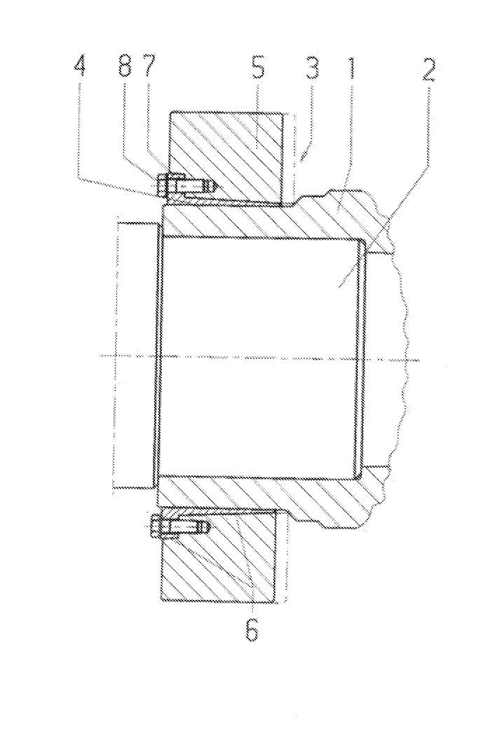

The instant application should be granted the priority date of Jul. 31, 2006 the filing date of the corresponding German patent application 10 2006 035 946.1.

### BACKGROUND OF THE INVENTION

The present invention relates to a slip or a contraction member to for establishing a press connection, preferably between two concentric shafts.

A press connection is provided between a hollow shaft and a connector shaft with the aid of such a slip or contraction member. To produce the press connection, the inner ring and the outer ring of the slip or contraction member are displaced relative to one another via the conical contact surface between the rings, and are thereby tightened, whereby the inner ring and the outer ring are elastically or elastically plastically deformed. The press connection can transmit torques, bending moments and forces. Critical for the transfer of moments and forces is the joint pressure produced by the slip or contraction member between the hollow shaft and the connector shaft, as well as the frictional value at this location. Steel is used as the material for the slip or contraction member.

It is an object of the present invention to provide a more economical manufacture of slip or contraction members of the aforementioned general type.

### BRIEF DESCRIPTION OF THE DRAWING

This object, and other objects and advantages of the present invention, will appear more clearly from the following specification in to conjunction with the accompanying schematic drawing, the single FIGURE of which shows a cross-section through a slip or contraction member.

### SUMMARY OF THE INVENTION

The slip or contraction member of the present application comprises an inner ring, and an outer ring, wherein the inner ring and the outer ring can be tightened against one another along a conical contact surface via a screw connection, and wherein the inner ring and/or outer ring is made of a cast iron material.

With the cast iron material, especially a spherulitic cast iron, a material is made available for the manufacture of slip or contraction members that for the application provided is more economical than is steel. Surprisingly, it has been shown that the cast iron material, relative to the stressing of the inner ring and the outer ring, is comparable to or has more favorable characteristics than does the steel that was previously used. With the same or an improved functionality of the slip or contraction member, the inventive member can thus be produced more economically.

Further specific features and advantages of the present application will be described in detail subsequently.

### DESCRIPTION OF SPECIFIC EMBODIMENTS

Referring now to the drawing in detail, a stub or connector shaft 2, which is connected, for example, with a gear mechanism, is inserted into a hollow shaft 1, which is preferably connected with a work or drive it machine. Placed or pressed onto the connection location of the hollow shaft 1 and the connector shaft 2 is a slip or contraction member 3, which is comprised of an inner ring 4 and an outer ring 5.

A portion of the outer periphery of the inner ring 4 is provided with a conical contact surface 6 that rests against a correspondingly shaped conical surface of the outer ring 5. The inner ring 4 is furthermore provided with a projection 7, which engages in a corresponding recessed portion of the outer ring 5.

A plurality of tightening screws 8 are guided through the projection 7; the tightening screws 8 respectively engage in an internal thread provided in the outer ring 5. By tightening the screws 8, the outer ring 5 is displaced along the conical contact surface 6 until the end faces of the inner ring 4 and of the outer ring 5 are flush with one another. In this connection, the inner ring 4 and the outer ring 5 are wedged accompanied by elastic deformation, thereby producing a press fit of the hollow shaft 1 upon the connector shaft 2.

The inner ring 4 and the outer ring 5 are preferably produced from a cast iron material. The cast iron material is preferably spherulitic cast iron, which may be tempered. A heat-treated ductile spherulitic cast iron (austempered ductile iron=ADI) can advantageously be used. Furthermore, it can also be advantageous to use gray cast iron, especially tempered gray cast iron.

The specification incorporates by reference the disclosure of German priority document 10 2006 035 946.1 filed 31 Jul. 2006.

The present invention is, of course, in no way restricted to the specific disclosure of the specification and drawing a but also encompasses any modifications within the scope of the appended claims.

What we claim is:

1. A slip or contraction member for establishing a press connection, comprising:
an inner ring (4), and
an outer ring (5), wherein said inner ring (4) and said outer ring (5) are adapted to be tightened against one another along a conical contact surface (6) via a screw connection, and wherein at least one of said inner ring (4) and said outer ring (5) is made of a cast iron to material.

2. A slip or contraction member according to claim 1, for establishing a press connection between two concentric shafts.

3. A slip or contraction member according to claim 1, wherein said cast iron material is a spherulitic cast iron.

4. A slip or contraction member according to claim 1, wherein said cast iron material is a tempered spherulitic cast iron.

5. A slip or contraction member according to claim 4, wherein said cast iron material is a heat-treated ductile spherulitic cast iron.

6. A slip or contraction member according to claim 1, wherein said cast iron material is a gray cast iron.

7. A slip or contraction member according to claim 1, wherein said cast iron material is a tempered gray cast iron.
